(19) United States
(12) Patent Application Publication
(10) Pub. No.: US 2007/0253642 A1
(43) Pub. Date: Nov. 1, 2007

(54) Method and apparatus for indexing, storing and retrieving raster (GRID) data in a combined raster vector system

(75) Inventors: Arthur R. Berrill, Ontario (CA); Anand Kannan, Ontario (CA)

Correspondence Address: DICKSTEIN SHAPIRO LLP, 1825 EYE STREET NW, Washington, DC, 20006-5403, US

(73) Assignee: MAPINFO CORPORATION

(21) Appl. No.: 11/411,847

(22) Filed: Apr. 27, 2006

(51) Int. Cl. G06K 9/54; G06K 9/48; G06F 17/30

(52) U.S. Cl. 382/305; 382/199; 707/3

(57) ABSTRACT

The invention relates to a method and apparatus that uses an R-tree's vector data as a mechanism for query and retrieval of raster data in conjunction with or instead of the vector data. The invention relates to a method of storing, indexing and retrieving raster data comprising: storing raster data, storing vector data, and indexing said raster data and said vector data with same index information.

### FIELD OF THE INVENTION

The invention relates generally to indexing, storing and retrieving raster and vector data together in a database to enhance performance and achieve operational efficiency.

### BACKGROUND OF THE INVENTION

Many electronic products, such as mapping systems, GIS's, computer aided design systems, and global positioning systems, require database storage of spatial data. In particular, they need to store raster and vector data and be able to query and retrieve arbitrary combinations of these data types. Due to cost considerations, many of these products have tight restrictions on processor performance, and on available on-board memory for mass database storage. Hardware restrictions of this nature are particularly troublesome for portable products, such as global positioning devices, involving embedded systems, because such systems require access to spatial (e.g., geographic/cartographic) data for mapping or navigation purposes. The volume of such data is quite large, and the available memory is limited by cost and physical size considerations.

One known and useful method of storing spatial data, in applications, utilizes an R-Tree index structure. R-Tree index structures allow the data to be accessed more efficiently than if randomly stored.

An R-Tree is a collection of nodes branched together in a meaningful or desired fashion. Conventional R-Trees are characterized by a root node representing at least the boundary of the entire spatial region packed and indexed by the R-Tree. All other nodes of the root are descendants of the root, with those nodes branched directly to the root being children of the root. Thus, the following statements are definitive of features in a tree structure, where x, y and z are nodes: if x is an ancestor of y, y is a descendent of x; if x and y are children of z, z is a parent of x and y, and x and y are siblings; if x has no children, x is a terminal node, commonly referred to as a leaf; and if x is not a leaf, it is an internal or branch node, and must be a parent.

More particularly, in original R-Tree structures, point, linear, and areal data features to be organized are represented by their minimum bounding rectangles. A minimum bounding rectangle, or bounding box, describes the maximum and minimum latitude and longitude (or x/y) extents of an object. Each node of the tree contains a collection of minimum bounding rectangles. At the leaf level, a collection of spatial features are grouped geographically, so that nearby features are stored together. Upper (non-leaf) nodes group a collection of nearby lower-level nodes, and serve to index the sub-level spatially. Typically, the number of sub-nodes grouped by a particular node has a fixed limit, say N. When a feature needs to be added to the tree, specific algorithms are used to search the existing tree for a leaf-level node suitable to contain the new feature. As the number of sub-nodes contained exceeds N, the node is split, and changes are propagated up the tree structure. The overall structure grows to create a tree structure with a single node at the top, bounding the entire geographic area covered by the database, and a collection of sub-levels, each of which covers a certain portion of the data coverage area. An R-Tree constructed this way grows dynamically (in width and height) as spatial features are added at the leaf level. The organization of the tree relative to the feature density in a particular geographic region is governed primarily by the value of N, which determines the number of sub-nodes (or features), at the leaf, the structure is able to represent. Given a specific rectangular area of interest, this data structure provides an efficient means to access spatial data.

Conventionally, leaf nodes in an R-Tree contain index record entries of the form (A, ID-Pointer) where “A” is a minimum bounding rectangle of the region indexed and “ID-Pointer” is a pointer to the region indexed. Particularly, in a two dimensional format, the rectangle A representing the indexed region is defined by [Xₘᵢₙ, Xₘₐₓ, Yₘᵢₙ, Yₘₐₓ] and “ID-Pointer” is the address of the rectangle A.

While the use of R-trees for indexing vector data has been well understood and used, raster images have typically been external to the vector indexing structure. Most systems that use raster and vector use differing indexing/partitioning schemes for the two forms of data. Space partitioning techniques such as quad-trees and tiles, and data based partitioning techniques such as R-trees and R*trees are used for vector data. Raster data is tiled based on a completely different criteria.

### BRIEF SUMMARY OF THE INVENTION

The invention relates to a method and apparatus that uses an R-tree's vector data as a mechanism for query and retrieval of raster data in conjunction with or instead of the vector data.

It is an object of the invention to provide a method of storing, indexing and retrieving raster data comprising: storing raster data; storing vector data; and indexing said raster data and said vector data with the same index information.

It is a further object of the invention to provide a method of storing, indexing and retrieving raster data comprising: storing raster data in a leaf node of a R-tree structure; storing vector data in said leaf node; and indexing said raster data and said vector data in said leaf node with the same index information.

It is a further object of the invention to provide a computer readable storage medium containing a computer readable code for operating a computer to perform a method for storing, indexing and retrieving raster data comprising: storing raster data in a leaf node of a R-tree structure; storing vector data in said leaf node; and indexing said raster data and said vector data in said leaf node with the same index information.

It is a further object of the invention to provide a system for storing, indexing and retrieving raster data comprising: means for storing raster data; means for storing vector data; and means for indexing said raster data and said vector data with the same index information.

It is a further object of the invention to provide a system for storing, indexing and retrieving raster data comprising: at least one leaf node, said at least one leaf node having a memory device associated with an index comprising: at least one unit of raster data; and at least one unit of vector data, wherein said at least one unit of raster data and said at least one unit of vector data are associated with the index.

It is a further object of the invention to provide a computer program transmitted over a communication medium to a computer system, the computer system comprising memory, a storage device and a processor in communication with the memory and the storage device, the computer program causing the processor to perform the acts of: storing raster data; storing vector data; and indexing said raster data and said vector data with the same index information.

It is a further object of the invention to provide an image structure comprising: a R-tree comprising: a plurality of leaf nodes, said leaf nodes comprising raster data and vector data in a memory device associated with an index, wherein said raster data and said vector data are associated with the same index.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is an illustration of a simplified R-tree structure;

FIG. 2 illustrates the hierarchal flow chart of the layering of the R-tree structure of FIG. 1;

FIG. 3 is a flow diagram illustrating an exemplary embodiment of the present invention; and

FIG. 4 is a processor system including the present invention.

### DETAILED DESCRIPTION OF THE INVENTION

The invention proposes that the R-trees (or its variants, such as R*trees) for the vector data be reused as a mechanism for query and retrieval of raster data in conjunction with or instead of the vector data.

Typically, in the prior art, the vector feature would first be retrieved or queried and then a buffer created. The imagery would be requested and the buffer would then be used to clip the imagery, and finally the image footprint and the attribution would be joined. When the image and vector data exist in the same leaf of the index, the raster data can readily be cut with the vector representation (e.g., the buffer) within the single query and with only one index lookup.

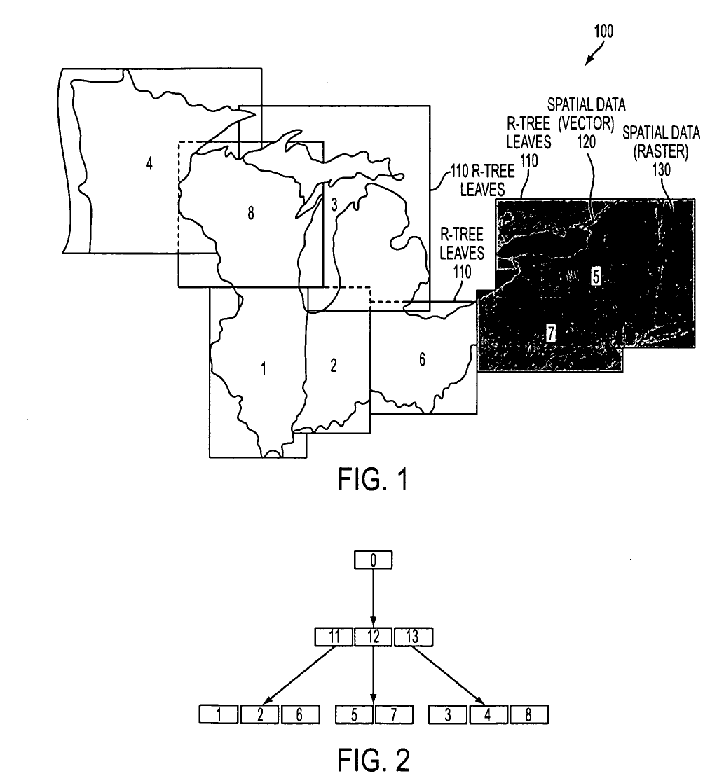

FIG. 1 is an illustration of a simplified R-Tree constructed in accordance with the invention. FIG. 2 illustrates the hierarchal flow chart of the layering effect of the R-tree structure 100 of FIG. 1. Referring to FIGS. 1 and 2, the invention uses the Minimum Enclosing Rectangle (MER) of the vector feature that already exists in the R-tree implementation. The MERs spatial data 120 storage design is used as a footprint for now storing the corresponding raster data 130. Thus, for each spatial data 120 feature there is one or more raster data 130 tiles associated with the MER of the spatial data feature.

The strength of the described embodiment is that both the raster and vector representation of the data are “index organized,” i.e., physically laid out such that a search on the R-tree 100 produces the data values themselves rather than a reference to a row in the database.

R-tree leaves 110 (i.e., leaf nodes 1-8) overlap. Thus, the overlap must be managed either by simply duplicating the raster overlap in the various footprints or by storing the overlap only once and referencing it from various footprints.

Some conventional spatial operators are faster or more efficient when raster data is used while others work better with vector data. This invention allows the most efficient operator to be used.

Moreover, it allows the rapid update of features, the retrieval of both raster and vector features 120, 130 simultaneously and in the case of surface features, the rapid extraction of the exact footprint from the MER. When spatial data is retrieved, the index search descends the R*tree on the primary pass seeking the MER(s) that include the required data. If imagery is required, then the data retrieved would also be the raster data resident in or pointed to by the MER. This is a common requirement, as for example, when a user wants to display information about a property. The spatial search would retrieve the property boundaries, the building and at the same time, the aerial imagery of the same region. While the vector information shows the legal boundaries, the imagery shows vegetation, existing fences, etc., thus complementing the vector information. It should be appreciated that techniques traditionally used in vector R-tree implementations for locking minimal parts of R-trees during updates can be applied to updating raster data.

The leaf nodes 110 raster storage may be extended to advanced forms of storage. For example, multi-resolution representations may be held in the leaf nodes rather than the raw images. When the images are stored as multi-resolution leaves, the R-tree search capability can accept the scale and zoom level information from the application.

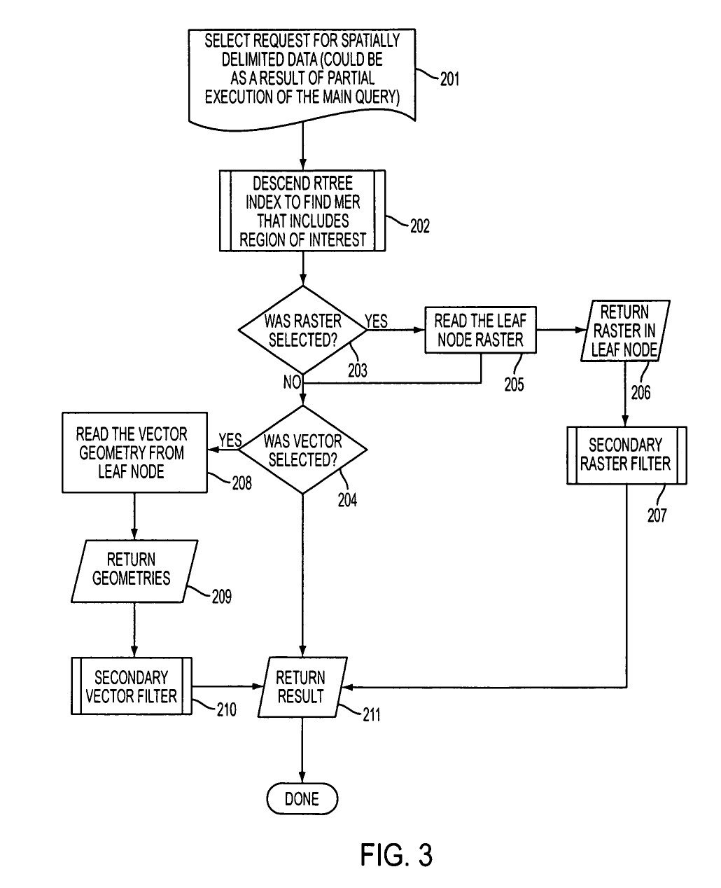

Referring to FIG. 3, which is a flow diagram of the exemplary embodiment of the present invention, shows the present invention indexing raster and vector data in the same index information. In step 201, a request for spatially delimited data is accepted as normal and then, in step 202, a search descends the R*tree looking for the MER that includes the required area. In step 203, when the MER is found, the invention determines whether or not a raster was selected. If the answer is yes, in step 205, the leaf node raster information is read and is then returned in the leaf node (step 206) through a secondary raster filter (step 207).

If the invention finds that raster was not selected, in step 204, the invention determines whether or not a vector was selected. If so, in steps 208, 209 and 210, the vector geometry from the leaf node is read and returned through a secondary vector filter. Once the raster or vector data has been returned through either the secondary raster filter or the secondary vector filter, in step 211, the invention returns a result. If neither raster or vector was selected, the MER passes through the invention and outputs a result, as also shown in step 211. The retrieved MER is thus processed within the database query using the MR techniques to return a single resolution coverage of the MER in question. After the search, the image is rendered to a suitable resolution and scale, thus tailoring the output to the needs of the caller.

Referring back to FIG. 1, indexing both the raster and vector data 120, 130 with the same index within the MER would also reduce storage space usage in the spatial information memory (not shown). For example, a raster result of a vector spatial operation could be readily returned. Consider the typical geographic query to display all the water-bodies within 100 kilometers of a highway segment. In conventional systems, in which the storage and indexing of vector data is separated from raster data, the query will be performed with the help of R-tree indices, the water bodies returned identified either by unique identifiers, or by vector representations of geometry. The user would then need to query data regarding the water bodies to form the raster representation of the region as an additional step.

However, the invention allows the user to query both the vector data and raster data tiles 120, 130 that represent the area covered by the water bodies. This is due to the vector data and raster data tiles 120, 130 being stored together at the leaf node 110 of the R-tree 100. This enables the search mechanism to return attribute information, vector data and raster backdrop data as a single row in the result set (i.e., all information needed to form a representation of the pertinent area).

As another example, the invention can be used for highlighting and visually validating the results of a query. Suppose, for example, that a query was made of a data store holding land parcels and some attribution leading to the valuation of those parcels. The query could ask the system to show all the properties with a value higher than some number (e.g., $300,000) and are considered “rural.” In the conventional system, the polygons that enclose the parcels returned by the query would probably be filled or shaded with a distinctive color so that the results could be distinguished. However, the invention provides a display that is more effective for the user. The queried properties are displayed as raster imagery (e.g., aerial photography or orthophotography) and only the queried properties are shown in this manner, while the remaining properties displayed as part of the R-tree structure are displayed in a default shading. As a result, a great deal more information can be conveyed to the user more efficiently and easier to interpret than under the conventional ways. In other words, the properties that are truly “rural” should be easier to recognize. With the raster footprints organized into the spatial index as accomplished by the invention, the process of returning such “highlights” is less processing intensive, more responsive and more effective.

As another example, both raster and vector data 120, 130 updates are more efficient. A database having the invention has the ability to hold both raster and vector data 120, 130 of a region where rapid development is under way on a highway. As this highway develops, aerial photography is taken periodically to update the road representation. While the original photography may have covered the entire country, the new imagery being continuously updated only relates to the area including the road. Using the invention, the leaves 110 that carry the imagery of the road may be readily updated without affecting the other unchanged imagery. Additionally, the vector representation of the road may be updated at the same time since the same leaf node indexes both the vector and raster data 120, 130 that forms the representation of the road.

As another example, it is possible with the invention to retrieve results of spatial analysis of the surrounding area of the road where required. With a single query and with one index lookup, a buffer can be created around the road and will function as a template to cut out the raster imagery, leaving only the footprint pertaining to the buffer of the road. As described above, a query can then be formed to search either or both the raster footprint and/or the vector data, and a representation may be returned.

It should be additionally appreciated that although the present invention has been described in relation to a number of examples, in no way do those examples limit the present invention. The present invention can be applied to any system, industry or field that deals with raster imagery. The present invention can be applied to any analysis system relating to indexing, storing and retrieving raster and vector data from databases to form images. It should also be appreciated that the manner in which the imagery and/or data is obtained, or the type of equipment used to obtain the imagery and/or data is also not limited to the above described examples.

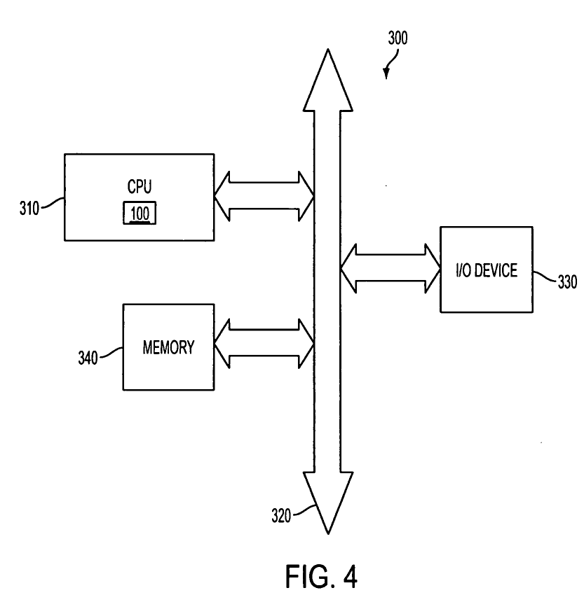

FIG. 4 shows system 300, a processor system modified to include the system for indexing, storing and retrieving raster and vector data in a R-tree structure 100 of the present invention. Examples of processor based systems, which may employ the system for indexing, storing and retrieving raster and vector data in a R-tree structure 100, include, without limitation, computer systems, machine vision systems, vehicle navigation systems, video telephones, surveillance systems, and others.

System 300 includes a central processing unit (CPU) 310 that communicates with various devices over a bus 320. Some of the devices connected to the bus 320 provide communication into and out of the system 300, illustratively including an input/output (I/O) device 330 and system for storing data in a R-tree structure 100. Other devices connected to the bus 320 provide memory, illustratively including a CPU 310 incorporating the system for indexing, storing and retrieving raster and vector data in a R-tree structure 100. While one input/output device 330 is shown, there may be multiple I/O devices such as a CD-ROM, hard drive, floppy disk, display, and keyboard as well as others. The system for indexing, storing and retrieving raster and vector data in a R-tree structure 100 may also be combined with a processor, such as a memory, digital signal processor, or microprocessor, in a single integrated circuit.

Additionally, the invention may be a software program stored on a computer readable storage medium (e.g., ROM) and executed by the processor. The stored information can be stored on a floppy disk, CD-ROM, RAM, HDD or any other suitable medium. The stored information could be in a table, database, or data structure suitable for use in indexing, storing and retrieving raster and vector data.

Having described specific preferred embodiments of the invention with reference to the accompanying drawings, it is to be understood that the invention is not limited to those precise embodiments, and that various changes and modifications may be effected therein by one skilled in the art without departing from the scope or the spirit of the invention as defined in the appended claims.

What is claimed as new and desired to be protected by Letters Patent of the United States is:

1. A method of storing, indexing and retrieving raster data comprising:
storing raster data;
storing vector data; and
indexing said raster data and said vector data with the same index information.

2. The method of claim 1, wherein the storing steps comprise storing said raster data and said vector data in a leaf node of a R-tree structure.

3. The method of claim 1, further comprising retrieving said raster data and said vector data using the same index information.

4. The method of claim 1, further comprising querying said raster data and said vector data using the same index information and displaying a raster image based on said raster data and said vector data.

5. A method of storing, indexing and retrieving raster data comprising:
storing raster data in a leaf node of a R-tree structure;
storing vector data in said leaf node; and
indexing said raster data and said vector data in said leaf node with the same index information.

6. A computer readable storage medium containing a computer readable code for operating a computer to perform a method for storing, indexing and retrieving raster data, said method comprising:
storing raster data;
storing vector data; and
indexing said raster data and said vector data with the same index information.

7. The method of claim 6, wherein the storing steps comprise storing said raster data and said vector data in a leaf node of a R-tree structure.

8. The method of claim 6, further comprising retrieving said raster data and said vector data using the same index information.

9. The method of claim 6, further comprising querying said raster data and said vector data using the same index information and displaying a raster image based on said raster data and said vector data.

10. A system for storing, indexing and retrieving raster data comprising:
means for storing raster data;
means for storing vector data; and
means for indexing said raster data and said vector data with the same index information.

11. The system of claim 10, wherein the means for storing comprise storing said raster data and said vector data in a leaf node of a R-tree structure.

12. The system of claim 10, further comprising means for retrieving said raster data and said vector data using the same index information.

13. The system of claim 10, further comprising means for querying said raster data and said vector data using the same index information and means for displaying a raster image based on said raster data and said vector data.

14. A system for storing, indexing and retrieving raster data comprising:
a processor coupled to an R-tree structure, said R-tree structure comprising:
at least one leaf node, said at least one leaf node having a memory device associated with an index comprising:
at least one unit of raster data; and
at least one unit of vector data,
wherein said at least one unit of raster data and said at least one unit of vector data are associated with the index.

15. A computer program transmitted over a communication medium to a computer system, the computer system comprising memory, a storage device and a processor in communication with the memory and the storage device, the computer program causing the processor to perform the acts of:
storing raster data;
storing vector data; and
indexing said raster data and said vector data with the same index information.

16. An image structure comprising:
a R-Tree comprising:
a plurality of leaf nodes, said leaf nodes comprising raster data and vector data in a memory device associated with an index, wherein said raster data and said vector data are associated with the same index.
